(19) United States
(12) Patent Application Publication
(10) Pub. No.: US 2026/0278700 A1
(43) Pub. Date: Sep. 17, 2026

(54) CALCULATING ENVIRONMENTAL ATTRIBUTES WITH PROCESS MEASUREMENT DATA

(71) Applicant: BASF SE, Ludwigshafen am Rhein (DE)

(72) Inventors: Claudius KORMANN, Ludwigshafen am Rhein (DE); Eberhard FUCHS, Ludwigshafen am Rhein (DE); Stefan BRUEGGEMANN, Ludwigshafen am Rhein (DE)

(21) Appl. No.: 19/472,959

(22) PCT Filed: Apr. 2, 2024
(86) PCT No.: PCT/EP2024/058834

§ 371 Date: Oct. 6, 2025

(30) Foreign Application Priority Data
Apr. 6, 2023 (EP) 23166954.0

(51) Int. Cl. G06Q 50/04

(52) U.S. Cl. CPC G06Q 50/04

(57) ABSTRACT

Disclosed are computer-implemented systems and methods for determining an environmental attribute for two or more chemical products produced in a chemical production process of a production plant.

### TECHNICAL FIELD

The present disclosure relates to methods, apparatuses and systems for producing at least one chemical product associated with one or more environmental attribute(s) and for calculating an environmental attribute of a chemical product based, at least in part, on process measurement data.

### TECHNICAL BACKGROUND

In production processes, the allocation of environmental attributes to co-products is of great interest. The allocation of environmental attributes can aid the collective reduction of environmental impacts to combat climate change. The accuracy of the allocations, however, is hindered by systems that do not account for the differing characteristics that co-products may have when they are different materials. Thus, there is a need to develop systems and methods that more accurately determine and allocate the environmental attributes of co-products.

### SUMMARY

In an aspect, the disclosure relates to a computer-implemented method for determining an environmental attribute for two or more chemical products produced in a chemical production process of a production plant comprising:
receiving an input environmental attribute associated with one or more input materials to the chemical production process;
receiving process data for one or more process steps in the chemical production process;
identifying based on the process data at least one process step producing from the one or more input materials two or more chemical output products, wherein the two or more chemical products includes a first chemical product and a second chemical product;
determining based, at least in part, on process measurement data associated with the first chemical product an environmental attribute for the first chemical product;
calculating an environmental attribute for the second chemical product based, at least in part, on the input environmental attribute and the environmental attribute for the first chemical product; and
outputting the environmental attribute for the first chemical product and the environmental attribute for the second chemical product.

In another aspect the disclosure relates to a system for determining an environmental attribute for two or more chemical products produced in a chemical production process of a production plant comprising:
an input configured to receive (i) an input environmental attribute associated with one or more input materials to the chemical production process and (ii) process data for one or more process steps in the chemical production process;
a processor configured to (i) identify based on the process data at least one process step producing from the one or more input materials two or more chemical output products, wherein the two or more chemical products includes a first chemical product and a second chemical product (ii) determine based, at least in part, on process measurement data associated with the first chemical product an environmental attribute for the first chemical product and (iii) calculate an environmental attribute for the second chemical product based, at least in part, on the input environmental attribute and the environmental attribute for the first chemical product; and
an output configured to output the environmental attribute for the first chemical product and the environmental attribute for the second chemical product.

In another aspect the disclosure relates to a computer-implemented method for determining an environmental attribute for two or more chemical products produced in a chemical production process of a production plant comprising:
receiving an input environmental attribute associated with one or more input materials to the production process;
receiving process data including information about one or more process steps from the one or more input materials to the two or more products, wherein the two or more products includes a first product and a second product;
determining an environmental attribute for the first product by referencing a preexisting value for the environmental attribute for the first product;
calculating an environmental attribute for the second product based, at least in part, on the input environmental attribute and the environmental attribute for the first product; and
outputting the environmental attribute for the first product and the environmental attribute for the second product.

In an aspect the disclosure relates to a computer-implemented method for determining an environmental attribute for two or more chemical products produced in a chemical production process of a production plant comprising:
receiving an input environmental attribute associated with one or more input materials to the chemical production process;
receiving process data for one or more process steps in the chemical production process;
identifying based on the process data at least one process step producing from the one or more input materials two or more chemical output products, wherein the two or more chemical products includes a first chemical product and a second chemical product;
determining based, at least in part, on process measurement data associated with the first chemical product an environmental attribute for the first chemical product;
calculating an environmental attribute for the second chemical product based, at least in part, on the input environmental attribute and the environmental attribute for the first chemical product; and
allocating, to the second chemical product, the environmental attribute for the second chemical product.

In another aspect, the disclosure relates to a computer-implemented method for determining an environmental attribute for two or more chemical co-products, including a first chemical coproduct and a second chemical co-product, produced in a chemical production process of a production plant comprising:
receiving an input environmental attribute associated with one or more input materials to the chemical production process;
receiving process data for one or more process steps in the chemical production process;
identifying based on the process data at least one process step producing from the one or more input materials two or more chemical output products, wherein the two or more chemical products includes the first chemical co-product and the second chemical coproduct;
determining based, at least in part, on process measurement data associated with the first chemical co-product an environmental attribute for the first chemical co-product;
calculating an environmental attribute for the second chemical co-product based, at least in part, on the input environmental attribute and the environmental attribute for the first chemical co-product; and
outputting the environmental attribute for the first chemical co-product and the environmental attribute for the second chemical co-product.

In yet another aspect disclosed is a computer element, in particular a computer program product or a computer readable medium, with instructions, which when executed on one or more computing node(s) are configured to carry out the steps of any of the methods disclosed herein. In yet another aspect disclosed is a computer element, in particular a computer program product or a computer readable medium, with instructions, which when executed by a processor cause any of the apparatuses disclosed herein to perform any of the methods disclosed herein.

Disclosed is in yet another aspect the use of one or more chemical products(s) associated with one or more environmental attribute(s) as provided by any of the methods disclosed herein and/or produced by a chemical production network as provided by any of the methods disclosed herein to produce at least one discrete product or at least one end product associated with the one or more environmental attribute(s). The at least one discrete product or the at least one end product may be an intermediate or end product of a product supply chain. The at least one discrete product or the at least one end product may be based on one or more chemical products(s). The at least one discrete product or the at least one end product may be produced by discrete manufacturing. Disclosed is in yet another aspect a method for producing at least one discrete product or at least one end product associated with the one or more environmental attribute(s), wherein the target material associated with one or more environmental attribute(s) as provided by any of the methods disclosed herein and/or produced by a chemical production network as provided by any of the methods disclosed herein is provided and/or used to produce the at least one discrete product or at least one end product associated with the one or more environmental attribute(s).

In yet another aspect the present disclosure relates to a computer element with instructions, which when executed on one or more computing node(s) is configured to carry out the steps of the method(s) of the present disclosure or configured to be carried out by the apparatus(es) of the present disclosure.

Any disclosure, embodiments and examples described herein relate to the methods, the systems, apparatuses, chemical products and computer elements lined out above and below. Advantageously, the benefits provided by any of the embodiments and examples equally apply to all other embodiments and examples.

### EMBODIMENTS

The public, regulators, and financial investors are increasingly concerned with the environmental impacts of chemical production processes. Major companies, in turn, have announced ambitious plans to track and manage the environmental impacts associated with the production of their products. When chemical production processes produce two or more co-products, it can be difficult to accurately allocate environmental attributes to the co-products.

Traditionally, environmental attributes are attributed (or allocated) using mass balancing. In this approach, the environmental attributes are allocated according to the mass ratio of the resulting co-products. In many cases, however, the co-products are different materials with different characteristics. The allocation of environmental attributes based on mass ratio does not account for the differentiated characteristics that different materials may have. Thus, traditional allocation schemes such as mass balancing can result in an inaccurate loading of the environmental impacts to co-products that have different characteristics.

There are a number of technical challenges that can make it difficult to accurately determine the loading of the environmental attributes for co-products including: complex reaction pathways, side reactions and by-products, variable reaction efficiencies and process variations. Chemical reactions involved in the production process can be complex and involve multiple steps. Different reactions may have varying dependencies on the input materials, making it difficult to isolate the exact contribution of each input material to a specific output material. Chemical reactions can lead to the formation of unintended by-products or side reactions. These by-products may consume or utilize some of the input materials, making it harder to accurately allocate the contribution of each input material to a specific output. The efficiency of the reactions in converting input materials to output materials can vary. Input materials may be distributed unevenly between output materials. Factors such as reaction conditions, catalysts, or impurities in the input materials can impact the efficiency, leading to non-linear and varying relationships between input and output quantities. Industrial chemical production processes often involve variations in operating conditions, such as temperature, pressure, or composition. These variations can influence the yield and selectivity of the reactions, further complicating the determination of input material requirements for specific output materials. Analyzing and measuring the quantities of input and output materials accurately can be challenging. Analytical techniques may have limitations in detecting or quantifying certain compounds or impurities, making it difficult to assess their contribution to a specific output material accurately.

An object of the present disclosure is to provide a system and method for more accurately allocating environmental attributes to co-products.

The systems, methods, and apparatuses of the present disclosure enable more accurate calculations of environmental attributes in chemical processing and provide chemical products with positive environmental impact through the value chain. In general, the input values to a chemical reaction are known. If, however, there are two or more output values that are unknown, then the equation describing the reaction is not uniquely solvable without additional information (e.g., an independent calculation). According to the disclosure, a computing system may use process measurement data (to provide additional information from an independent calculation) to determine output values including environmental attributes (e.g., Product Fossil Footprint or Product Carbon Footprint). By using process measurement data associated with at least one co-product to determine the value of an environmental attribute for that co-product, the values of the environmental attributes for other co-products can be more accurately calculated. Specifically, for chemical networks that produce more than one chemical product from more than one input material via interconnected, connected and non-connected production chains, the use of process measurement data to determine an environmental attribute for a coproduct enables a more accurate calculation of the environmental attribute(s) of the remaining co-product(s) produced in a chemical process. Chemical products may have identifiers which enables the reliable assignment of environmental attributes to the chemical products in line with the physical setup of the chemical production network. An “environmental attribute” can be, for example, an environmental impact or measure, a social impact or measure, an environmental compensation measure, a social compensation measure, any calculated impact of a product, precursor product, intermediate or raw material. This way the environmental impact of the coproducts can be made transparent to customers (who may be further processing the coproducts). By more accurately allocating environmental attributes to chemical products, the chemical production process may be adjusted to increase efficiency and/or mitigate the environmental impact of the chemical production process.

In the following, embodiments of the present disclosure will be outlined by way of examples. It is to be understood that the present disclosure is not limited to said embodiments and/or examples.

Carbon footprint or Product Carbon Footprint (PCF) may refer to the amount of greenhouse gases (GHG) emitted or removed in a production process at a manufacturing facility, expressed as carbon dioxide equivalent. The PCF can be assessed from cradle-to-gate (partial PCF) or from cradle-to-grave (total PCF)

Fossil footprint or Product Fossil Footprint (PFF) may refer to the amount of petrochemical feedstocks (e.g., naphtha, crude oil, coal, and natural gas, or intermediates from feedstocks that, in turn, require a certain amount of naphtha, crude oil, coal, and natural gas) consumed in a production process at a manufacturing facility. PFF may be expressed as kilogram methane per kilogram (or methane equivalent).

Environmental attributes may refer to a property or characteristic related to the environmental impact. Such a property may be a property or characteristic of the input materials and/or of chemical products. The environmental attribute may indicate an environmental performance of one or more material(s) and/or the performance of one or more chemical product(s). The environmental attribute may be produced from properties of the input materials, the chemical production network and/or the chemical products. The environmental attribute may be associated with the environmental impact of one or more material(s) at any stage during the lifecycle of the material or products made of the material. The stages of the material lifecycle may include the stages of providing input material, producing products, such as intermediate products or end products, using products, treating end-of-life products, recycling end-of-life products, disposing end-of-life products, reusing components from end-of-life products or any subset of stages. The environmental attribute may be specified or may be produced from any activity of one or more entities participating at any stage of the lifecycle of one or more material(s) or product(s) made of such material(s).

The environmental attribute may include one or more characteristic(s) that are attributable to environmental or sustainability impact of the material or product. The environmental attribute may include environmental, technical, recyclability, circularity or complementary risk characteristics(s), characteristic(s) associated with the environmental impact of one or more material(s) or product(s).

Environmental characteristic(s) may specify or quantify ecological criteria associated with the products environmental impact. Environmental characteristic(s) may be or may be produced or derived from measurements taken during the lifecycle of one or more product(s). Environmental characteristics may be determined at any stage of the product lifecycle and may characterize the environmental impact of the product for such stage or up to such stage. Environmental characteristic(s) may for example include impact categories such as fossil footprint, carbon footprint, greenhouse gas emissions or global warming potential, primary energy demand, cumulative energy demand, biotic and abiotic resource consumption, air emissions, stratospheric ozone depletion potential, ozone formation, terrestrial and/or marine acidification, water consumption, water depletion, water availability, water pollution, noise pollution, freshwater and/or marine eutrophication potential, human carcinogenic and/or non-carcinogenic toxicity, photochemical oxidant formation, particulate matter formation, terrestrial, freshwater and/or marine ecotoxicity, ionizing radiation, agricultural and/or urban land occupation, land transformation, land use, indirect land use, deforestation, biodiversity, mineral resource consumption, fossil resource consumption. The environmental impact may specify or quantify a product fossil footprint (PFF) which refers to the amount of petrochemical feedstocks (e.g., naphtha, crude oil, coal, and natural gas, or intermediates from feedstocks that in turn require a certain amount of naphtha, crude oil, coal, and natural gas) consumed in a production process at a manufacturing facility.

Environmental characteristic(s) may be calculated from combinations of one of more environmental characteristics. Environmental characteristic(s) may for example include product or material characteristics related to the production of the material or product like renewable, bio based, vegan, halal, kosher, palm oil-free, natural or the like.

The environmental attribute may be a digital asset associated with the input material(s) or chemical product(s). The environmental attribute may digitally specify the environmental impact of the input material or the chemical product. The environmental attribute may relate to fossil footprint or carbon footprint. The environmental attribute may relate to a renewable, a bio-based and/or a recycled content e.g., of the input material and/or chemical product. The environmental attribute may include a qualitative data point relating to the type of impact e.g., in view of the input material or the chemical product. The environmental attribute may specify a type such as recycled, renewable and/or bio-based. The qualitative data point may be converted to a quantitative measure such as environmental units or balancing units. The environmental attribute may include a quantitate data point relating to the type of impact e.g., in view of the input material or the chemical product, recycled content, renewable content or bio-based content. The environmental attribute may specify recycled, renewable and/or bio-based content. The environmental attribute may include further environmental characteristics of the input or chemical product.

Calculated product characteristics may refer to Product Fossil Footprint, Product Carbon Footprint, energy consumption, water consumption, crude oil consumption, labor (e.g., person hours associated with producing a product), social burdens (e.g., injuries and/or accidents associated with the production of a product), and other products characteristics that can be measured and calculated.

Process measurement data refers empirical data collected from large-scale chemical production processes that accurately reflect the calculated product characteristics of an output material (e.g., its Product Fossil Footprint, Product Carbon Footprint, and the like). This data may be obtained through rigorous and standardized analytical techniques, such as chromatography, spectroscopy, and mass spectrometry, that can detect and quantify the relevant chemical species and impurities. A computing system may then process and analyze the data to derive meaningful insights into the environmental attribute(s) of input and/or output materials for a chemical production process. For example, the computing system may average or aggregate the data over specific time intervals and/or process conditions. The computing system may normalize and scale the data to bring it into a standardized scale. The computing system may apply filtering techniques to, for example, detect and remove outliers or erroneous measurements (e.g., due to equipment malfunctions or other factors) from the data. Process measurement data is a technical resource that provides a reliable basis for optimizing chemical production processes, improving their efficiency and sustainability, and ensuring compliance with regulatory requirements. For example, process measurement data may be empirical data from large-scale chemical production processes that accurately reflect the Product Fossil Footprint and/or the Product Carbon Footprint of a co-product.

According to the disclosure, process measurement data may be used to provide an accurate value for the environmental attribute(s) of one or more co-products of a chemical production process. As is further described below, a computing system may calculate an environmental attribute of a co-product through a calculation in which the input resources (e.g., masses and attributes of the inputs) are approximately balanced by the output resources (e.g., masses and attributes of the inputs). One or more of the values associated with the co-products may be unknown. Process measurement data provides a valuable reference point in an equation with two (or more) unknowns. Specifically, if the equation has at least one unknown that can be determined from process measurement data, then the data can serve as a constraint that narrows down the range of possible solutions and leads to a more accurate determination of the remaining unknowns.

Process measurement data involves the collection, analysis, and utilization of data obtained from real-world industrial processes. Process measurement data may involve the collection of data using technical instruments and sensors. This data may be obtained through specialized measurement techniques, such as chromatography, spectroscopy, or mass spectrometry, which are technical in nature. The data represents physical measurements of attributes such as composition, purity, yield, and efficiency, providing technical information about the chemical production process. Process measurement data requires processing and analysis using technical methods and algorithms. This involves data manipulation, statistical analysis, and mathematical modeling to derive meaningful insights and conclusions about the performance and characteristics of the chemical production process. The processing and analysis of the data involves technical expertise and techniques that may be specific to the field of chemical engineering or industrial process optimization. Process measurement data may be utilized for process optimization, control, and decision-making. The data may be used to improve the efficiency, sustainability, and reliability of chemical production processes. It may guide the optimization of resource allocation, waste reduction, and energy efficiency, all of which are technical considerations. The utilization of process measurement data involves the application of technical knowledge and expertise to improve industrial processes. Process measurement data is used in real-world industrial applications to monitor, analyze, and/or control chemical production processes. It may be employed to ensure compliance with regulatory requirements, improve product quality, improve the environmental impact of chemical production and/or enhance process safety. The implementation of process measurement data in industrial settings involves the use of technical systems, instruments, and software tools to collect, process, and utilize the data effectively. Process measurement data involves the collection, processing, analysis, and utilization of data obtained from real-world industrial processes. The data is technical in nature and may be applied to optimize and control chemical production processes.

A computing system using process measurement data provides several advantages for calculating, monitoring, and tracking the environmental attributes of input and output materials in a large interconnected chemical production network including (1) improved accuracy and reliability, (2) enhanced efficiency and speed, (3) comprehensive analysis and reporting, (4) increased transparency and traceability, and (5) facilitated decision-making. A computing system using process measurement data enables accurate and reliable estimation of the environmental attributes of input and output materials in real-time, allowing for better decision-making and resource allocation. The system can process vast amounts of empirical data and transform it into usable process measurement data, reducing errors and inaccuracies associated with manual calculations. A computing system using process measurement data can operate in real-time, continuously monitoring and tracking the environmental attributes of input and output materials. The system can automatically apply the process measurement data in-line with production, reducing the need for manual interventions and improving the speed and efficiency of the process. A computing system using process measurement data can generate detailed reports and analysis of the environmental attributes of input and output materials, providing valuable insights into the performance of the chemical production network. The system can identify areas of improvement, optimize resource allocation, and ensure compliance with regulatory requirements. A computing system using process measurement data provides increased transparency and traceability of the environmental attributes of input and output materials, enabling better tracking and monitoring of the production process. The system can identify the source and composition of input materials, track their usage throughout the production process, and monitor the environmental impact of the output materials. A computing system using process measurement data provides a reliable and comprehensive basis for decision-making in chemical production processes. The system can generate insights and recommendations based on the analysis of process measurement data, allowing for informed and data-driven decision-making. A computing system using process measurement data provides significant advantages for calculating, monitoring, and tracking the environmental attributes of input and output materials in a large interconnected chemical production network. It improves accuracy and reliability, enhances efficiency and speed, provides comprehensive analysis and reporting, increases transparency and traceability, and facilitates decision-making, ultimately leading to improved process optimization and environmental sustainability.

The term “input material” as used in the present disclosure may refer to any good which is bought from suppliers and brought to the production plant. The input material may include starting material used in the production process of the production plant to produce the product. An input material can be on any step along the value chain like the product described above. This means, the product of the one production plant can be the input material of the other production plant. Input material can also include very fundamental goods like air, water, natural gas, sulfur or salt. Input material(s) may refer to petrochemical feedstocks such as naphtha, crude oil, coal, and natural gas, or intermediates from feedstocks that in turn require a certain amount of naphtha, crude oil, coal, and natural gas.

A “production plant” as used in the present disclosure may be any facility which is able to produce any kind of good which is sold to an end customer or further processed in a different production plant. A production plant can be on one single site or on multiple. If the production plant is in multiple sites, these have to be under common control which is typically the case if they belong to the same company or to affiliated companies. Examples for plants are power plants, steel manufacturing plants, oil producing plants, oil refineries, chemical plants, partial oxidation plants, plants for manufacturing pharmaceuticals, plants for manufacturing construction materials, machine manufacturing plants, automobile manufacturing plants, plants for manufacturing textiles, plants for manufacturing furniture, food production plants, plants for manufacturing consumer electronics such as cell phones, plants for manufacturing and/or processing of paper, such as a printing press.

Chemical production networks may include multiple types of production processes for producing different chemical products from input materials. The chemical production network may include a complex production network producing multiple chemical products in multiple production chains. The chemical production network may include connected, interconnected and/or nonconnected production chains. The connection may be provided by the fact that a process, an operation and an entry point are located within the same building, or within a common fence, or within any other security or organizational containment that is an indication that the operations are controlled by a company. Connectivity may be provided by a concept called “Scope 1” (cf. Greenhouse gas protocol, https://ghgprotocol.org/sites/default/files/standards/ghg-protocolrevised.pdf), a definition of organizational boundaries, determining the operations owned or controlled by a company. An indicator of connectedness may be a pipe for delivering and sharing any raw material, intermediate, products, utilities such as steam, water, waste water or a common sewage pipe. The chemical production network may produce from input materials multiple intermediates and from intermediates chemical products. Input material may enter the chemical production network at entry points. Chemical product may leave the production network at exit points.

The chemical production network may comprise one or more entry points at which input materials are provided to the chemical production network. Input material may include fossil material, non-fossil material or both. Fossil input material may include crude oil, natural gas, coal, or derivates of those. Non fossil input material may include renewable material, bio-based material or recycled materials. Input material may include feedstock for a gasification plant, a steam cracker or synthesis gas plant. Input material may include synthesis gas produced from fossil feedstock, non-fossil feedstock or both. Input material may include for example pyrolysis oil from recycled waste, syngas produced from recycled waste, naphtha produced from bio-based material, methane from bio-based material, or combinations thereof. Input material may be provided to at least one gasification plant, steam cracker or synthesis gas plant, or any plant of the production chain for downstream products such as nitrogen, ammonia, methanol, ethylene, propylene, sulfur or the like. Input material may include intermediate chemical products produced elsewhere with fossil and/or non-fossil input materials. Input material may include anorganic materials with mineral origin, salts, metals, glass or the like.

The input material associated with one or more environmental attribute(s) provided to the entry point of the chemical production network may include recycled input materials including, but not limited to, recycled pyrolysis oil, recycled pyrolysis gas, recycled synthesis gas, recycled hydrogen, recycled naphtha, recycled methane, recycled ethane, recycled propane, recycled chemicals or combinations thereof. Recycled chemicals may include, but may not be limited to, recycled ammonia, recycled methanol, recycled ethylene, recycled propylene, recycled benzene, recycled toluene, recycled xylene or combinations thereof. Recycled chemicals may include, but may not be limited to, recycled glass, glass fibres, metals, alloys, recycled polymers, recycled oligomers, recycled monomers, or combinations thereof. In the context provided here recycled input material may include any material that at least in part includes recycled content and/or is at least in part produced from recycled content. The recycled content may be but does necessarily have to be physically and/or chemically traceable. The recycled content can be a calculated property of a product. The recycled content can be conveyed by a chain of custody method such as a mass balance model or a book and claim model or a combination of both models.

The input material associated with one or more environmental attribute(s) provided to the entry point of the chemical production network may include bio-based input materials including, but not limited to, bio-based pyrolysis oil, bio-based pyrolysis gas, bio-based synthesis gas, biobased hydrogen, bio-based naphtha, bio-based methane, bio-based ethane, bio-based propane, bio-based chemicals or combinations thereof. Bio-based chemicals may include, but may not be limited to, bio-based ammonia, bio-based methanol, bio-based ethylene, bio-based propylene, bio-based benzene, bio-based toluene, bio-based xylene or combinations thereof. Biobased chemicals may include, but may not be limited to, bio-based polymers, bio-based oligomers, bio-based monomers or combinations thereof. In the context provided here bio-based input material may include any material that at least in part includes bio-based content and/or is at least in part produced from bio-based content. The bio-based content may be but does necessarily have to be physically and/or chemically traceable. The bio-based content can be a calculated property of a product. The recycled content can be conveyed by a chain of custody method such as a mass balance model or a book and claim model or a combination of both models.

“Recycled content” or “bio-based content” are non-exhaustive examples for calculated environmental attributes of a product.

The chemical production network may include multiple production steps for one or more production chains. The production steps included in the chemical network may be defined by the physical system boundary of the chemical production network. The system boundary may be defined by location or control over production processes. The system boundary may be defined by the site of the chemical production network. The system boundary may be defined by production processes controlled by one entity or multiple entities jointly. The system boundary may be defined by value chain with staggered production processes to an end product, which may be controlled by multiple entities separately. The chemical production network may include a waste collection step, a waste sorting step, a recycling step such as chemical recycling through pyrolysis, a cracking step such as steam cracking, a partial oxidation step such as a synthesis gas plant, a separation step to separate outputs of one process step and further processing steps to convert such outputs to chemical products leaving the system boundary of the chemical production network. The entry points of the chemical production network may be marked by the entry of input materials to the chemical production network. The input materials entering the chemical production network may be used to produce one or more chemical products. The chemical products may leave the physical system boundary of the chemical production network. The exit points of the chemical production network may be marked by the exit of chemical products from the chemical production network.

The chemical product may be produced by the chemical production network to which the input material(s) associated with one or more environmental attribute(s) were provided. The chemical product may be produced by a production chain of the chemical production network to which the input material(s) associated with one or more environmental attribute(s) were provided. The chemical product may be produced from the input material(s) associated with one or more environmental attribute(s).

In an embodiment, the method further comprises dividing the chemical production process into at least two process steps based on the process data. Such a process is typically needed if the process data is not available in a format which attributes all information directly to a process step, but is only available in a format from which this information is derivable.

In an embodiment, the method further comprises calculating an environmental attribute for an intermediate produced in a preceding process step and using the environmental attribute for the intermediate as an input for the calculation of the environmental attribute for the second chemical product. In interconnected production processes, the calculation of the environmental attribute can be facilitated by subdividing it into analogous calculation parts, one for each process step.

In an embodiment, allocating, to the second chemical product, the environmental attribute for the second chemical product comprises associating a QR code with the second chemical product.

In an embodiment, allocating, to the second chemical product, the environmental attribute for the second chemical product comprises associating a token with the second chemical product.

In an embodiment, the computer-implemented method further comprises:
generating an operational instruction related to the production of the second chemical product based on the environmental attribute for the second chemical product; and
outputting the operational instruction.

In an embodiment, the computer-implemented method further comprises:
generating an operational instruction related to the production of the second chemical coproduct based on the environmental attribute for the second chemical co-product; and
outputting the operational instruction.

The terms “first chemical product” and “first chemical co-product” may be used interchangeably. Similarly, the terms “second chemical product” and “second chemical co-product” may be used interchangeably.

Chemical co-products are products that are generated as outputs from a chemical production process.

In an embodiment, the environmental attribute for the second chemical product is associated with an amount of petrochemical feedstock consumed in the chemical production process to make the second chemical product. In such an embodiment, the environmental attribute of a chemical product may refer to the amount of petrochemical feedstocks (e.g., naphtha, crude oil, coal, and natural gas, or intermediates from feedstocks that in turn require a certain amount of naphtha, crude oil, coal, and natural gas) consumed in a production process at a manufacturing facility.

In an embodiment, the process measurement data relates to an amount of petrochemical feedstock consumed in the chemical production process to make the first chemical product. In such an embodiment, the process measurement data may refer to preexisting data that quantifies the amount of petrochemical feedstocks (e.g., naphtha, crude oil, coal, and natural gas, or intermediates from feedstocks that in turn require a certain amount of naphtha, crude oil, coal, and natural gas) consumed in a production process for one or more the chemical products.

The production plant may be affiliated with a set of companies that are under common control (e.g., group companies, legal entities). Within the group companies, a parent company may have the ability to direct the financial and operating policies of the companies. The group companies may include incorporated and non-incorporated joint ventures and partnerships.

According to the Greenhouse Gas Protocol (GHG) Standard or the European Commission Product Environmental Footprint (PEF 2021) three scopes are defined: Scope 1 may relate to GHG emissions from chemical production within the system boundary of the chemical production network. For example, Scope 1 emissions may include emissions from chemical processes, incineration and/or waste treatment at plant or sub-cluster level of the chemical production network. Scope 2 GHG emissions may relate to the generation of purchased energy, such as electricity and/or steam used to power plants and/or chemical processes of the chemical production network. Scope 3 GHG emissions may relate to input materials or other resources provided to the chemical production network.

In an embodiment, the environmental attribute for the second chemical product is associated with an amount of greenhouse gases (GHG) emitted or removed in a production process to make the second (and/or first) chemical product. In such an embodiment, the environmental attribute of a chemical product may refer to the amount of greenhouse gases (GHG) emitted or removed in a production process at a manufacturing facility, expressed as carbon dioxide equivalent.

In an embodiment, the process measurement data relates to an amount of greenhouse gases (GHG) emitted or removed in a production process to make the first (and/or second) chemical product. In such an embodiment, the process measurement data may refer to preexisting data that quantifies the amount of greenhouse gases (GHG) emitted or removed in a production process for one or more the chemical products (and may be expressed as carbon dioxide equivalent).

In an embodiment, the production plant executes interconnected process steps. The term “interconnected” refers to an embodiment in which at least one process step uses two intermediates of different other process steps or uses one intermediate of different other process steps each producing this intermediate or yields two intermediates which are used in two different other process steps. Hence, the production plant executes interconnected process steps. In some embodiments, the production plant is a chemical production plant executing interconnected process steps. Often, the interconnected process steps are executed in different factories, maybe on different sites, potentially operated by different group companies.

In an embodiment, the process data may be gathered through an interface to different production plants, such as different computing or storage resources communicatively connected to the different production plants. The process data may be gathered through an interface to enterprise resource planning systems of different group companies, The process data may be consolidated to identify intermediates produced by one group company and used by a different group company.

In an embodiment, the output comprises a user interface configured to display the environmental attribute for the first chemical product and/or the environmental attribute for the second chemical product. The user interface may provide a graph to visually represent the environmental attributes associated with the chemical products. In some embodiments, the user interface may illustrate the contributions to the environmental attributes along the production process. In some embodiments, a user may use the user interface to analyze the contributions to the environmental attributes and to monitor, manage, and/or adjust the production process to, for example, minimize the environmental attributes the chemical products.

In an embodiment, the processor is further configured to calculate an environmental attribute for an intermediate produced in a preceding process step and use the environmental attribute for the intermediate as an input for the calculation of the environmental attribute for the second chemical product. In interconnected production processes, the calculation of the environmental attribute can be facilitated by subdividing it into analogous calculation parts, one for each process step.

### BRIEF DESCRIPTION OF THE DRAWINGS

In the following, the present disclosure is further described with reference to the enclosed figures. The same reference numbers in the drawings and this disclosure are intended to refer to the same or like elements, components, and/or parts.

FIG. 1 Illustrates an example of a part of a chemical production network producing multiple chemical products(s) from fossil and non-fossil input material(s).

FIG. 2 Illustrates selected aspects of a chemical production network according to the disclosure.

FIG. 3 Is a block diagram illustrating selected aspects of an electronic system according to the disclosure.

FIG. 4. Is a block diagram illustrating an electronic system and process measurement data according to the disclosure.

FIG. 5. Is a high-level block diagram illustrating an example of a chemical production network coupled with an operating system according to the disclosure.

FIG. 6 Illustrates an example in which the production plant includes two group companies C1 and C2.

### DETAILED DESCRIPTION

The present disclosure is in the field of computer-implemented systems and methods for determining and calculating the environmental attributes (e.g., fossil input material requirement, energy consumption, water consumption, carbon footprint, etc.) of products made in the production processes of production plants.

The disclosed system and process can be applied to a wide variety of products that are made from input materials, such as chemical products or precursor products. The term “product” may refer to any commodity that can be sold to others at any point in the value chain. This may include end products for end users (e.g., cars, paints, toys, or medicines). This may also include goods that are typically sold to other companies for further processing (e.g., steel parts for machinery, plastic pellets for extrusion, or chemical compounds such as acrylic acid to make superabsorbents for diapers). This may also include goods that are very early in the value chain such as crude oil fractions (e.g., naphtha), agricultural products (e.g., soybeans), or purified sand for glass production.

The present disclosure comprises the step (a) receiving an input environmental attribute associated with one or more input materials to the chemical production process. For most input materials, the input environmental attribute can be obtained or derived from information provided by the supplier (e.g., a BoM, digital product passport, etc.). The environmental attribute can be obtained from another operation from a Scope 1 company. In some cases, the input environmental attribute may be from public or private databases. Different suppliers may provide the same input material with different input environmental attributes due to differences in the material's production process or logistics. Therefore, the input environmental attributes may be gathered for each supplier together with an identifier of the supplier. This information can then be used to calculate the environmental attribute of a particular input material depending on how much of the input material is used from which supplier. Priority rules may be defined for cases when environmental attributes for one input material are available from multiple sources. Priority rules may depend on data quality or certification of the source. The result may be taken into account when determining and/or calculating the environmental attribute for a chemical product. In rare cases, the input environmental attributes are not available. In these cases, the input environmental attribute may be estimated, for example by comparison to very similar products on the market. The input environmental attribute of each input material is typically gathered through an interface. The input environmental attribute of each input material can be received through an interface to a local or a remote database or an ERP system, in particular its supply chain module, or any computing system or apparatus, such as a centralized or decentralized computing system or apparatus including processing and storage. The input environmental attribute of each input material may hence be gathered from an ERP system or any computing system or apparatus, such as a centralized or decentralized computing system or apparatus including processing and storage. Usually, the input environmental attribute of each input material is gathered through an interface to more than one database. It is therefore often necessary to convert the information retrieved from different databases into a single format to allow further processing. In particular, the input environmental attribute obtained from databases have to be attributed to the input material, i.e. the identification of a input material in the database has to be translated to the identification of the input material of the process data used in the process according to the present disclosure.

The present disclosure comprises the step (b) receiving process data for one or more process steps in the chemical production process. The process data may comprise information about the process steps from the required input materials to the product. A “process step” in the context of the present disclosure is generally a series of acts onto the input materials which cannot be reasonably separated in time or space. Typically, all acts of one process step take place in one building using certain dedicated equipment. The production process of the production plant may include one or more process step(s). The process data may include a digital representation of the one or more process step(s) of the production process.

The process data can comprise information regarding which reagents are required at which amounts for each process step. The process data may comprise the digital representation of one or more process step(s) of the production process and such representation may include or may be associated with the information regarding which reagents are required at which amounts for the one or more process step(s). A “reagent” can be an input material or an intermediate of a different process step. An “intermediate” refers to a good, such as a substance, which is neither an input material nor a product, but is made from input materials or earlier intermediate and is processed further into other intermediates and finally into the product. Each process step may require one or more reagent(s). The “amount” of a reagent refers to the mass, the volume or the number of pieces per intermediate or product depending on the nature of the reagent, intermediate and/or product. The mass is typically used for bulk goods, such as metals. The volume is typically used for liquids, such as water or glycerol. The number of pieces is typically use for individualized goods, such as screws or plastic pieces. All these units are given per unit of intermediate or product, for example 0.5 kg of reagent 1 per kg of product.

The process data can comprise information about which by-products are obtained in which amount for one or more process step(s). The process data may comprise the digital representation of one or more process step(s) of the production process and such representation may include or may be associated with the information relating to which by-products are obtained in which amount for respective process step(s). Some process steps may not produce any byproducts, such as the assembly of steel parts. In this case, the process data does not comprise information about by-products. However, many process steps produce by-products.

A distinction may be drawn between a by-product and a “residue.” In the context of the present disclosure a residue refers to any good which is unavoidably obtained in a process step but cannot be used in a different process step. Sometimes, a residue can be recycled, i.e. be subjected to another process step or multiple process steps to obtain an input material or an intermediate which can be used as a reagent in a process step. However, in some cases, there is no economically feasible use for the residue. In this case, the residue has to be disposed. It can, for example, be burned in an incinerator. If the incineration is part of the production plant, the thermal and/or electrical energy regained may preferably be taken into account. It may also be transferred to a sewage plant to be flared or, in the case of carbon dioxide, it may also be stored in emptied gas fields.

The process data can comprise the information regarding which intermediate or intermediates are obtained in each process step and at which yield. The process data may comprise the digital representation of one or more process step(s) of the production process and such representation may include or may be associated with the information regarding which intermediate or intermediates are obtained in the one or more process step(s) and at which yield. The “yield” in the context of the present disclosure refers to the percentage of outcome from a particular process step relative to the theoretical maximum. If the yield is 100%, for example if ingredients are mixed into a formulation, the process data does not have to comprise information about the yield. However, the yield can be below 100% if there are losses in a process step. In chemical reactions, the yield is typically below 100%, because of side reactions and losses upon purifications. In other processes, yields can also be below 100%, for example if steel parts are cut or drilled, there may be a certain percentage that are defective and the defective goods may cause a loss unless they can be reused. In chemistry, defect goods may be referred to as off-spec material which may be reproduced, sold as “secunda” or treated as waste or residue.

The process data can comprise information about any direct environmental impact by the process step (e.g., petrochemical feedstock consumption, greenhouse gas emission, etc.). These environmental impacts may stem from a chemical reaction of the input materials which consumes petrochemical feedstock(s). These environmental impacts may also stem from a chemical reaction of the input materials which either contains greenhouse gases or generates greenhouse gases during the process step, for example, by heating. A typical example is cement production in which carbon dioxide evolves from heating the input materials, in particular from heating limestone. The process data may comprise the digital representation of one or more process step(s) of the production process and such representation may include or may be associated with information about direct environmental impact(s) by respective process step(s). The information about direct environmental impacts may contain, for example the information about which (and the amount(s) of) petrochemical feedstocks are consumed and/or which greenhouse gases are emitted (and the associated amounts). The amount can be given relative to the amount of input materials or relative to the amount of product or intermediate of the respective process step. The latter can be derived from the former by multiplying with the yield of the process step.

In the easiest case, one or multiple input materials are processed in one process step to arrive at the product. An example could be that certain cables and plugs are the input materials which are assembled to form a cable tree as a product which is sold to car manufacturers. In most cases, however, the production processes are more complicated. Multiple input materials are processed into various intermediates which are processed into various products, wherein one input material can be used to produce more than one intermediate and one intermediate may be used to produce more than one product. In such a situation, the final environmental attribute of one product may depend on the environmental attributes of other products produced at the production plant. Hence, typically the process data comprise the information regarding which reagents are required at which amounts for each process step for all products having at least one reagent or intermediate in common.

The present disclosure comprises the step (c) identifying based on the process data at least one process step producing from the one or more input materials two or more chemical output products, wherein the two or more chemical products includes a first chemical product and a second chemical product. For many production plants, the process data comprises the information regarding which reagents are required at which amounts for each process step for at least two products having at least one reagent or intermediate in common. The process data may comprise the digital representation of one or more process step(s) of one or more production process(es). Such representation may include or may be associated with information regarding which reagents are required at which amounts for one or more process step(s) for at least two products having at least one reagent or intermediate in common. For complex production plants the process data comprise the information regarding which reagents are required at which amounts for each process step for at least five or at least ten products having at least one reagent or intermediate in common. The process data may comprise the digital representation of one or more process step(s) of one or more production process(es). Such representation may include or may be associated with information which reagents are required at which amounts for each process step for at least five or at least ten products having at least one reagent or intermediate in common.

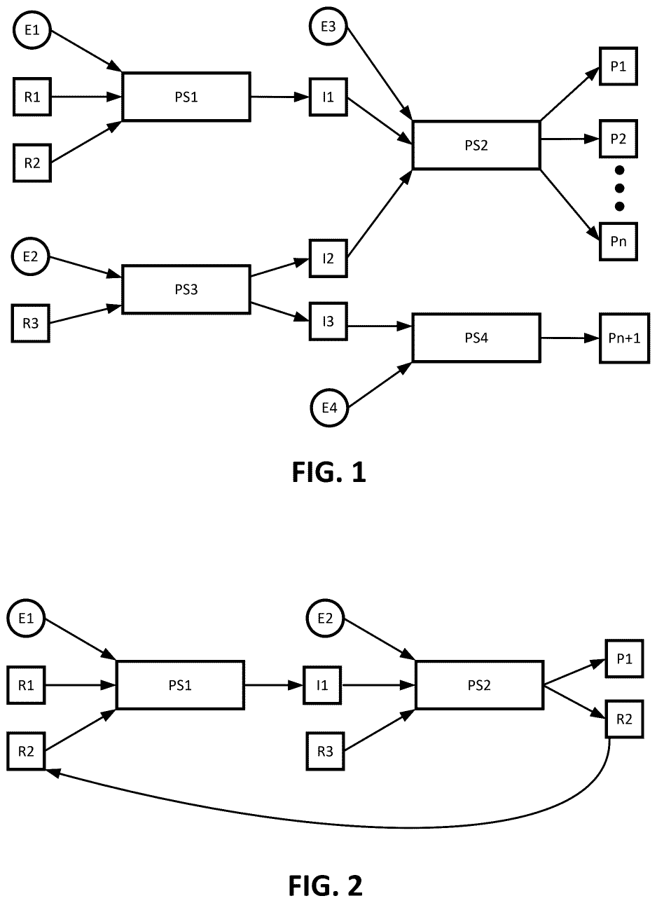

FIG. 1 illustrates an example of a part of a chemical production network producing multiple chemical products from fossil and non-fossil input material(s). The input materials are denoted as R1, R2 and R3, the products are denoted as P1-Pn+1. The intermediates (i.e., all goods which are neither input materials nor products) are denoted as I1, I2 and I3. The energy required for each production process is denoted as E1, E2, E3 and E4. The process steps are denoted as PS1, PS2, PS3 and PS4. Input materials R1 and R2 are processed in a first process step PS1 to produce intermediate I1 using the energy E1. In the next process step PS2, intermediate I1 is processed with intermediate I2 using the energy E3 to arrive at product P1, P2 and Pn. Intermediate I2 is also made within the same production plant in process step PS3 by processing input material R3 using the energy E2. In process step PS3, another intermediate I3 is obtained which can be further processed in another process step PS4 using energy E4 to arrive at product Pn+1. It can easily be recognized that the input materials R1, R2 and R3 as well as the energies E1, E2 and E3 have an impact on the environmental attributes of products P1, P2 and Pn. In addition, however, the usage of I3 may have an impact because, if the demand for product Pn+1 changes, either the input of I3 cannot be used completely because of too low demand for product Pn+1, a higher percentage of the environmental attribute of R3 and the environmental impact due to E2 may have to be attributed to I2 and consequently to P1, P2 and/or Pn. Therefore, it is usually necessary to provide complete information about all input materials and all process steps in a production plant, at least in case there are connections between different chains of process steps from input materials to the products. The process data may comprise the digital representation of one or more process step(s) of one or more production process(es). Such representation may include or may be associated with information about input materials and process steps in one or more production plant(s), in case there are connections between different chains of process steps from input materials to the products.

FIG. 2 shows another example which can particularly occur in the chemical industry. Input materials R1 and R2 are processed in a first process step PS1 to produce intermediate I1 using the energy E1. In the next process step PS2, intermediate I1 and input material R3 are processed using the energy E2 to arrive at product P1 while the reagent R2 is also obtained. R2 can be reused in process step PS1, so a cycle is formed. In this situation, the process data may contain information on how much of reagent R2 is used from a supplier and how much recycled reagent R2 obtained in process step PS2 is used.

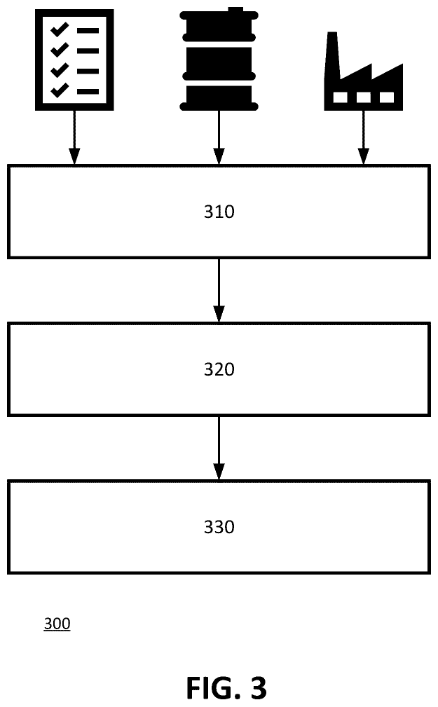

FIG. 3 is a block diagram illustrating selected aspects of an electronic (i.e., computing) system according to the disclosure. According to the disclosure, the electronic system may be used for a number of purposes including the collection, processing, analysis, and utilization of data related to the mass balance approach in feedstock substitution. The mass balance approach may involve the use of recycled or renewable raw materials as alternatives to fossil resources at the beginning of a chemical production value chain. The alternative feedstocks may be attributed to downstream products via the mass balance approach. While mass-balanced products may retain their product properties compared to their conventional equivalents, they contribute to the substitution of fossil resources in a chemical production process and may have a smaller product carbon footprint than their conventional equivalent. The electronic system may, for example, calculate how much fossil input (or raw) material is needed to produce a particular amount of input material. After the electronic system calculates the amount of fossil input material that is needed, it may provide (e.g., output) operational instructions to replace some (or all) of a fossil input material with an amount of a sustainable input material. Thus, system 300 may be used to produce a mass balance product. Electronic system 300 includes input (or input unit) 310 which may be configured to receive (i) one or more input environmental attribute(s) associated with one or more input materials to a chemical production process and (ii) process data for one or more process steps in the chemical production process that may be required to make chemical products from the one or more input materials. In the present disclosure, the chemical production process produces two or more co-products (e.g., a first chemical product and a second chemical product). Processor or processing unit 320 is configured to determine an environmental attribute of one or more of the co-products (e.g., for a first chemical product). According to the disclosure, processing unit 320 determines the environmental attribute of a co-product based on process measurement data. For example, processing unit 320 may reference a digital file (such as a lookup table, a database, a memory or storage location, etc.) that contains the environmental attribute of a co-product based on process measurement data. Processing unit 320 may take into account the information obtained from the input unit 310 and consolidating the environmental attributes thus obtained to arrive at the environmental attributes of the product. Output or output unit 330 is configured to output the environmental attribute of the first chemical product.

The process data is typically gathered through an interface. The process data may be gathered from the production plant. It can be gathered through an interface to a local or a remote database. Preferably, the process data is gathered through an interface to an enterprise resource planning (ERP) system or any computing system or apparatus, such as a centralized or decentralized computing system or apparatus including processing and storage. In this way, the process data may be gathered from the ERP system or any computing system or apparatus. The ERP system or any computing system or apparatus may obtain the information from the production plant. In this case, the process data may by gathered from the production plant via the ERP system or any computing system or apparatus. In this way, the process data may be updated or instantly updated once any change in the production plant or its surrounding occurs. Depending on the ERP system or the computing system or apparatus “instantly” may mean in less than or equal to one day, preferably less than or equal to six hours, in particular less than or equal to one hour. A typical example of such a change would be that the production plant receives insufficient reagent from a different factory and has to use an external supply instead. Such an external supply usually has a different product carbon footprint than the internal intermediate, hence changing the carbon footprint of the product produced in the production plant. Another advantage of an ERP is system is that the data is standardized and validated, i.e. it is reliable and typically does not need further validation.

An “ERP system” in the context of the present disclosure shall have its common meaning. A typical ERP system provides an integrated and continuously updated view of core business processes using common databases maintained by a database management system. ERP systems typically track business resources such as cash, input materials, production capacity and the status of business commitments: orders, purchase orders, and payroll. The applications that make up the system typically share data across various departments such as those responsible for manufacturing, purchasing, sales, accounting, that provide the data.

Preferably, in particular for more complex production processes, in particular for interconnected production processes, the method of the present disclosure further comprises subdividing the production process into at least two process steps based on the process data. Such a process may be needed, for example, if the process data is not available in a format which attributes all information directly to a process step, but is only available in a format from which this information is derivable.

As an example, the process data gathered from the production plant may contain the materials used as starting materials and the products produced, but not the information regarding which process step uses, as a starting (i.e., input) material, the product of another process step. Therefore, the method of the present disclosure may further contain determining for each process step which process step precedes this process step based on the amount of a particular starting (i.e., input) material used in this process step and the amount of the same material produced by other process steps. This can be achieved by identifying for each material, for example by a material identifier, all process steps which produce this material and all process steps which use this material as starting material. These process steps need to be connected. If more of a particular starting material is used in a process step than is produced by the other process steps, this difference can be identified as input material. The result can be validated by comparing the amount of input material of a certain material with the procurement information of this input material. Such procurement information can typically be obtained from the ERP system.

If the production plant(s) comprise multiple entities such as group companies, for example in different countries, the different entities such as group companies often use separate ERP systems or any computing system or apparatus, such as a centralized or decentralized computing system or apparatus including processing and storage. If an intermediate produced by one entity is shipped to another entity using this intermediate in another process step, the ERP systems or any computing system or apparatus, such as a centralized or decentralized computing system or apparatus including processing and storage may treat such operations as external transactions for legal reasons. However, for the purpose of the present disclosure, such data may be consolidated to identify intermediates produced by one group company and used by a different group company. Such information may be accessible from the ERP systems or may require other data sources, such as a shared database. Hence, preferably the process data is gathered through an interface to ERP systems or any computing system or apparatus of different group companies, wherein the process data is consolidated to identify intermediates produced by one group company and used by a different group company. The process data may be gathered through an interface to different production plants, preferably different computing or storage resources communicatively connected to the different production plants. The process data may be gathered through an interface to enterprise resource planning systems of different group companies, The process data may be consolidated to identify intermediates produced by one group company and used by a different group company.

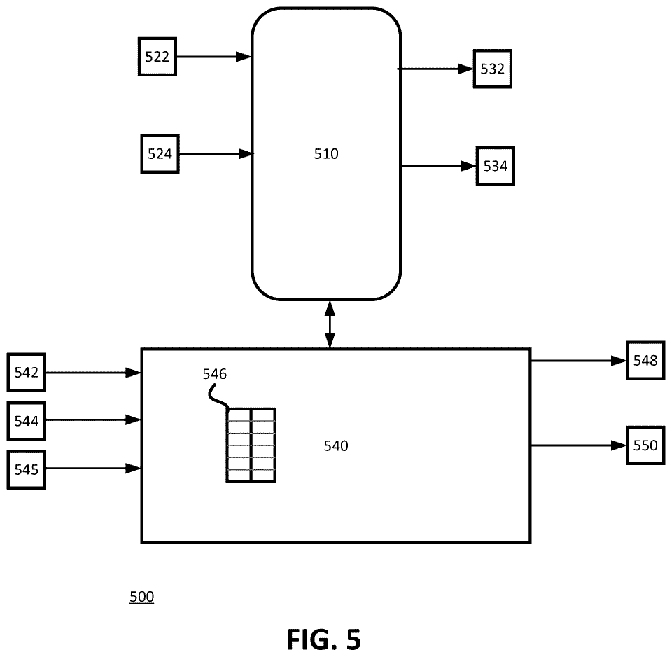

The present invention comprises step (d) determining based, at least in part, on process measurement data associated with the first chemical product an environmental attribute for the first chemical product. The process measurement data may be preexisting empirical data that indicates the environmental attribute(s) of a chemical product. The preexisting empirical data may be compiled from large-scale processes such as methanol from gas synthesis at million-ton annual scale. Referring, for example, to FIG. 5, the process measurement data may be organized as a digital look-up table that provides an environmental attribute for one or more of the chemical products 532-534. Process measurement data 546 may also be a value stored in (any tier of) memory (volatile or non-volatile) or data located in storage either co-located with or communicatively coupled (by any combination of wired and/or wireless networks) with operating system 540. In some cases, the process measurement data is located in public or private databases.

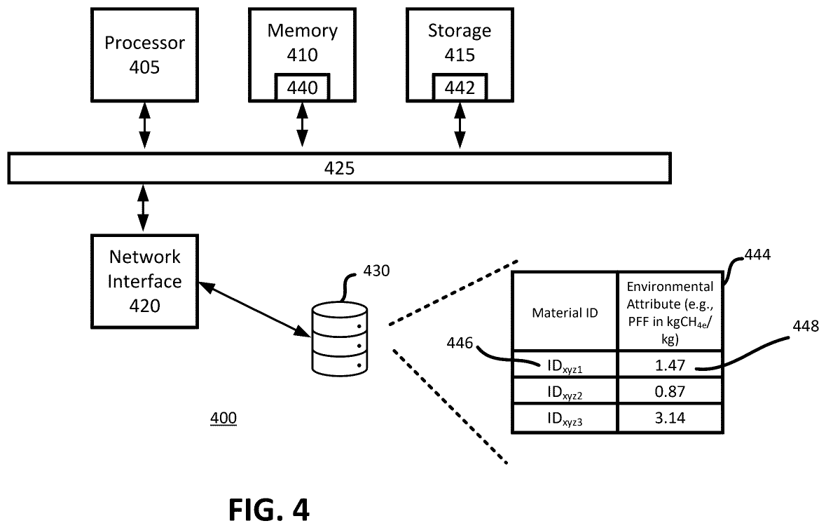

FIG. 4 is a block diagram illustrating electronic (i.e., computing) system 400 and process measurement data (440, 442, and 444) according to the disclosure. Electronic system 400 includes processor 405 which provides processing, operating management, and the execution of the instructions for system 400. Processor 405 may be any type of microprocessor, central processing unit, processing core, field programmable gate array (FPGA), application specific integrated circuit (ASIC), graphical processing unit, programmable controller, and the like. Processor 405 is communicatively coupled (e.g., via interconnect 425 and network interface 420) to memory 410, storage 415, and network interface 420. Network interface 420 may be coupled with database 430 through wired and/or wireless network(s) (and/or combinations thereof). System 400 includes process measurement data 440, 442 and/or 444. Processor 405 may access process measurement data 440, 442, and/or 444 to determine an environmental attribute(s) for a first chemical product. For example, processor 405 may access process measurement data 444 to determine if a material identifier associated with the first chemical product is listed in process measurement data 444 (as shown by 446). If so, then processor 405 may determine an environmental attribute for the first chemical product using a value stored in process measurement data 444 (e.g., the PFF value at 448).

The present disclosure comprises step (e) calculating an environmental attribute for the second chemical product based, at least in part, on the input environmental attribute and the environmental attribute for the first chemical product. For most input materials, the input environmental attribute can be obtained from information the supplier provides or from public or private databases. Usually, different suppliers provide the same input material with different input environmental attributes due to differences in its production process or logistics. Therefore, the input environmental attributes of an input material may be gathered for each supplier together with an identifier of the supplier. This information can then be used to calculate the input environmental attribute of that particular input material depending on how much of the input material is used from which supplier. The input environmental attribute of each input material is typically gathered through an interface. A processor (e.g., processor 405) may calculate the environmental attribute for the second chemical product because input and output resources are generally balanced and at least one of the output environmental attributes has been determined by process measurement data.

In an aspect of the disclosure, the calculation of the environmental attribute(s) may be based, at least in part, on the resource balancing between the input materials and the resulting chemical products. For example, the input resources (such as mass and the environmental attributes) are generally balanced with the output resources as shown by equations 1 through 5.

$${M}_{1} + {M}_{2} \to {M}_{3} + {M}_{4} ( where {M}_{i} : Material ) \qquad ( 1 )$$

$${m}_{1} + {m}_{2} \to {m}_{3} + {m}_{4} ( where {m}_{i} : Mass ( kg ) ) \qquad ( 2 )$$

$$- ( {m}_{1} {EA}_{1} + {m}_{2} {EA}_{2} ) ∼ ( {m}_{3} {EA}_{3} + {m}_{4} {EA}_{4} ) ( where {EA}_{i} : environmental attribute ) \qquad ( 3 )$$

$$- INPUT ∼ ( {m}_{3} {EA}_{3} + {m}_{4} {EA}_{4} ) \qquad ( 4 )$$

$${\sum }_{i = 1}^{r} - {m}_{i} {EA}_{i} ≅ {\sum }_{i = x - r + 1}^{x} {m}_{i} {EA}_{i} \qquad ( 5 )$$

Collectively, equations 1-5 illustrate that the input and output resources for a chemical process are substantially in balance. The input masses and environmental attributes (shown, for example, in equation 3) are typically available from the Bill of Materials (BoM) and upstream processes in a chemical production network. The mass (e.g., m₁, m₂) of input materials (M₁, M₂) may be reported with a negative sign in a BOM. However, in a few cases masses are reported with positive values. In such cases it is necessary to calculate the positive amounts of the sum products of each side of the equations. When the co-products are different materials, the specific values of the output environmental attributes may not be readily available since there are two unknown values in equation 3 (e.g., EA₃ and EA₄).

FIG. 5 is a high-level block diagram illustrating an example of a chemical production network 500 producing chemical products 532, 534 from two input material(s) 522, 524 in connection with an operating system 540 including process measurement data 546 according to the disclosure. Operation system 540 may receive input environmental attribute(s) 542 and input mass(es) 544 which are associated with input materials 522 and 524. Input environmental attributes 542 and input mass(es) 544 may be available from the BoM and/or upstream processes associated with input materials 522, 524. Operating system 540 may also receive process data 545 for one or more of the process steps in the chemical process to create chemical products 532, 534.

Operating system 540 may use the process data 545 to identify a process step(s) at which chemical production process 510 produces two or more co-products. For example, chemical production process 510 may produce a first chemical product 532 and a second chemical product 534. Operating system 540 may include (or, via a network, have access to) process measurement data 546. Process measurement data 546 may be preexisting empirical data that indicates the environmental attribute(s) of a material (such as chemical product(s) 532,534). The preexisting empirical data may be compiled from large-scale processes such as methanol from gas synthesis at million-ton annual scale. Process measurement data 546 may be organized as a digital look-up table that provides an environmental attribute for one more of the chemical products 532, 534. Process measurement data 546 may also be a value stored in (any tier of) memory (volatile or non-volatile) or data located in storage either co-located with or communicatively coupled (by any combination of wired and/or wireless networks) with operating system 540. In some cases, operating system 540 may access process measurement data 546 that is located in public or private databases. Operating system 540 may determine an environmental attribute(s) for one or more of the chemical products 532, 534 (e.g., it may use a lookup table to determine an environmental attribute for the first chemical product 532).

After determining the environmental attribute of the first chemical product 532, operating system 540 may more accurately calculate an environmental attribute for second chemical product 534 using, for example, the logic shown in equations 1-5. For example, with reference to equation 4 and FIG. 5, operating system 540 may determine the value of “INPUT” from the input environmental attribute(s) 542 and input mass(es) 544. With reference to equation 4 and FIG. 5, operating system 540 may determine the environmental attribute for the first chemical product by referencing process data 545 and process measurement data 546. Operating system 540 may then apply algebraic operations to calculate the remaining unknown value: the environmental attribute of the second chemical product 534. Operating system 540 may then output the environmental attribute of the first chemical product 548 and the environmental attribute of the second chemical product 550. Operating system 540 may also generate an operational instruction related to the production of the second chemical product based on the environmental attribute for the second chemical product. For example, operating system 540 may generate an operation instruction related to adjusting input material quantities, optimizing process parameters, predictive maintenance, quality control adjustments, real-time monitoring, and the like. Operating system 540 may then output and/or execute the operation instruction.

The present disclosure may be illustrated with reference to the isobutylene from methyl tertiary butyl ether (MTBE) production process (or MTBE cracking). Equation 6 illustrates the MTBE cracking process.

$$MTBE \to Methanol + Isobutene \qquad ( 6 )$$

Assume that the input material, MTBE, has a mass of 5.3 tons and the input environmental attribute is 5.3 (e.g., fossil feedstock equivalents or CO₂ equivalent to MTBE). The process creates 1.9 tons of methanol and 3.4 tons of isobutene. According to the disclosure, the determination of the environmental attribute for one of the co-products (e.g., methanol) may be determined by referencing process measurement data (e.g., a lookup table). The process measurement data may be generated with data from large-scale processes such as methanol from gas synthesis at million-ton annual scale. The referenced process data may indicate the specific feedstock requirement is approximately 0.6 tons of natural gas for 1 ton of methanol or 60%. Thus, the load of isobutene can be determined by the calculation shown in equation 7. The specific load is 122% as shown by equation 8.

$$5.3 - 1.9 * 0.6 = 4.16 \qquad ( 7 )$$

$$4.16 / 3.4 = 122 \% \qquad ( 8 )$$

To illustrate the accuracy of the disclosed method and system, consider the MTO process in which methanol can be converted into olefins (e.g., isobutene) on a large scale at moderate temperatures (approx. 500° C.) with a yield of over 90%. The process can be summarized in two steps:

$$C {H}_{3} O H \to [ C {H}_{2} ] + H2O ; and \qquad ( Step 1 )$$

$$4 [ {CH}_{2} ] \to {C}_{4} {H}_{8} ( isobutene ) . \qquad ( Step 2 )$$

Where the isobutene, in addition to the trimer propene and the dimer ethylene, is formed and evaluated according to the mass allocation. Four moles of methanol are required for 1 mole of isobutene, which is why the load ratio is calculated as follows:

$$4 * 32 grams methanol / 56 grams isobutene = 229 \% .$$

Table 1 illustrates the allocation of environmental attributes to the co-products methanol and isobutene according to three methods: (1) allocation by mass, (2) allocation according to the present disclosure, and (3) the MTO method (used as a reference).

TABLE 1

| | | According to the | |
|---|---|---|---|
| | State of the art | present disclosure | |
| | (allocation by | (e.g., look-up table | MTO method |
| Material | mass) | for methanol) | (for reference) |
| Methanol | 100% | 100% | 100% |
| Isobutene | 100% | 203% | 229% |

The highlighted values for isobutene show that, in comparison to the allocation by mass method, the present disclosure aligns more closely to the technical MTO method.

The steps (a), (b), (c), (d) and (e) can be performed consecutively or in parallel. It is also possible to perform two steps in parallel and the remaining step before or after.

The process according to the present invention further comprises (f) outputting the environmental attribute for the first chemical product and the environmental attribute for the second chemical product. Outputting can mean writing the carbon footprint on a non-transitory data storage medium, displaying it on a user interface, providing it to an interface for further processing or any combination thereof. It is also possible to provide the output through an interface to a customer, for example to the customers supply chain system or ERP system. It is also possible to provide the output through an interface to the EPR system of the producer itself from where it can be distributed to where this information is needed. When the environmental attributes for the chemical products are output onto a user interface, the user interface may use graph technology.

The method according to the present disclosure is particularly useful for production plants which execute interconnected process steps. The term “interconnected” in the context of the present invention means that at least one process step uses two intermediates of different other process steps or uses one intermediate of different other process steps each producing this intermediate or yields two intermediates which are used in two different other process steps. Hence, preferably, the production plant executes interconnected process steps. Even more preferably, the production plant is a chemical production plant executing interconnected process steps. Often, the interconnected process steps are executed in different factories, maybe on different sites, potentially operated by different group companies.

The environmental attributes obtained by the method of the present invention can also be used for optimizing the optimizing the environmental attributes of downstream products. The environmental attributes of the chemical products, for example, may be entered into a database together with other information about the product, such as the producer, the specifications, the price, or the availability. In this way, a manufacturer of downstream products may search for products having desirable environmental impacts such that they contribute a desired impact to the environmental attribute(s) of the downstream product and hence optimize the environmental impact of the downstream product.

The present invention further relates to a non-transitory computer readable data medium storing a computer program including instructions for executing steps of the method according to the present invention. Computer readable data medium include hard drives, for example on a server, USB storage device, CD, DVD or Blue-ray discs. The computer program may contain all functionalities and data required for execution of the method according to the present invention or it may provide interfaces to have parts of the method processed on remote systems, for example on a cloud system.

The present invention further relates to a system or apparatus for determining the environmental attribute of a product produced in a production process of a production plant. Unless explicitly described differently hereafter, the description relating to the method also applies to the system or apparatus. The system or apparatus can be a computing device, for example a computer, tablet, or smartphone, or a distributed computing system or apparatus or apparatus such as a cloud system. Often the computing device has a network connection in order to communicate with other computing devices, such as servers or a cloud network.

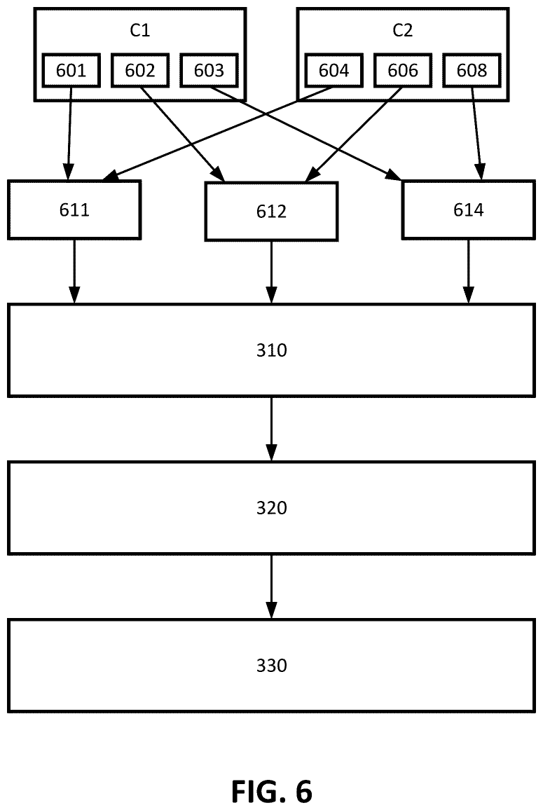

FIG. 6 shows a schematic view of a system comparable to that in FIG. 3, but the production plant involves two group companies C1 and C2. Each group company provides process data 601, 604, the environmental attribute of each input material 602, 606 and energy data 603, 608 through an interface to consolidation systems 611, 612, 614. The consolidation system 611 consolidates the process data to identify intermediates produced by one group company and used by a different group company. The consolidation system 612 consolidates the environmental attribute of each input material 602, 606 to arrive at one list of input materials with associated environmental attributes. The consolidation system 614 consolidates the energy data 603, 608 to arrive at a uniform data set of energy data.

The present disclosure has been described in conjunction with preferred embodiments and examples as well. However, other variations can be understood and effected by those persons skilled in the art and practicing the claimed invention, from the studies of the drawings, this disclosure and the claims.

Any steps presented herein can be performed in any order. The methods disclosed herein are not limited to a specific order of these steps. It is also not required that the different steps are performed at a certain place or in a certain computing node of a distributed system, i.e. each of the steps may be performed at different computing nodes using different equipment/data processing.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

Any disclosure and embodiments described herein relate to the methods, the systems, devices, the computer program element lined out above and vice versa. Advantageously, the benefits provided by any of the embodiments and examples equally apply to all other embodiments and examples and vice versa.

All terms and definitions used herein are understood broadly and have their general meaning.

Any disclosure and embodiments described herein are mere examples for implementing the method, the system or application device disclosed herein and shall not be considered limiting.

1. A computer-implemented method for determining an environmental attribute for two or more chemical products produced in a chemical production process of a production plant comprising:
receiving an input environmental attribute associated with one or more input materials to the chemical production process;
receiving process data for one or more process steps in the chemical production process;
identifying based on the process data at least one process step producing from the one or more input materials two or more chemical output products, wherein the two or more chemical products includes a first chemical product and a second chemical product;
determining based, at least in part, on process measurement data associated with the first chemical product an environmental attribute for the first chemical product;
calculating an environmental attribute for the second chemical product based, at least in part, on the input environmental attribute and the environmental attribute for the first chemical product; and
outputting the environmental attribute for the first chemical product and the environ mental attribute for the second chemical product.

2. The computer-implemented method of claim 1, wherein the method further comprises dividing the chemical production process into at least two process steps based on the process data.

3. The computer-implemented method of claim 1, wherein calculating the environmental attribute for the second chemical product further comprises calculating an environmental attribute for an intermediate produced in a preceding process step and using the environmental attribute for the intermediate as an input for the calculation of the environmental attribute for the second chemical product.

4. The computer-implemented method according to claim 1, wherein the environmental attribute for the second chemical product is associated with an amount of petrochemical feedstock consumed in the chemical production process to make the second chemical product.

5. The computer-implemented method according to claim 1, wherein the process measurement data relates to an amount of petrochemical feedstock consumed in the chemical production process to make the first chemical product.

6. The computer-implemented method according to claim 1, wherein the environmental attribute for the second chemical product is a Product Carbon Footprint (PCF) for the second chemical product.

7. The computer-implemented method according to claim 1, wherein the process measurement data relates to a Product Carbon Footprint (PCF) for the first chemical product.

8. The computer-implemented method according to claim 1, wherein the process data is gathered through an interface that couples two or more interconnected production plants.

9. A non-transitory computer readable data medium storing a computer program including instructions for executing steps of the method according to claim 1.

10. A system for determining an environmental attribute for two or more chemical products produced in a chemical production process of a production plant comprising:
an input configured to receive (i) an input environmental attribute associated with one or more input materials to the chemical production process and (ii) process data for one or more process steps in the chemical production process;
a processor configured to (i) identify based on the process data at least one process step producing from the one or more input materials two or more chemical output products, wherein the two or more chemical products includes a first chemical product and a second chemical product (ii) determine based, at least in part, on process measurement data associated with the first chemical product an environmental attribute for the first chemical product and (iii) calculate an environmental attribute for the second chemical product based, at least in part, on the input environmental attribute and the environmental attribute for the first chemical product; and
an output configured to output the environmental attribute for the first chemical product and the environmental attribute for the second chemical product.

11. The system according to claim 10, wherein the input comprises an interface to a consolidation system which collects data from different production plant(s), and wherein the consolidation system consolidates the process data to identify intermediates produced by different production plants.

12. The system according to claim 9, wherein the output comprises a user interface configured to display the environmental attribute for the first chemical product and/or the environmental attribute for the second chemical product.

13. The system according to claim 9, wherein the processor is further configured to calculate an environmental attribute for an intermediate produced in a preceding process step and using the environmental attribute for the intermediate as an input for the calculation of the environmental attribute for the second chemical product.

14. The system according to claim 9, wherein the environmental attribute for the second chemical product is associated with an amount of petrochemical feedstock consumed in the chemical production process to make the second chemical product.

15. The system according to claim 9, wherein the process measurement data relates to an amount of petrochemical feedstock consumed in the chemical production process to make the first chemical product.
